(19) United States
(12) Patent Application Publication
(10) Pub. No.: US 2015/0302832 A1
(43) Pub. Date: Oct. 22, 2015

(54) INFORMATION PROCESSING METHOD AND ELECTRONIC DEVICE

(71) Applicant: Lenovo (Beijing) Limited, Beijing (CN)

(72) Inventors: Bing Xie, Beijing (CN); Guangbin Li, Beijing (CN)

(21) Appl. No.: 14/553,514

(22) Filed: Nov. 25, 2014

(30) Foreign Application Priority Data
Apr. 16, 2014 (CN) 201410153254.7

(51) Int. Cl. G09G 5/36; G06T 1/20; G06F 3/14

(52) U.S. Cl. CPC G09G 5/363; G06F 3/1407; G06T 1/20; G06T 2200/28; G09G 2310/08; G09G 2360/127

(57) ABSTRACT

The present disclosure provides an information processing method, applied in an electronic device including a display unit and a first controller and having a first application installed thereon. The method comprises: displaying a first image of the first application on the display unit of the electronic device while the first application is running, the first image including a first region and a second region; detecting a time variation and changing the first region of the first image in response to the time variation; and activating the first controller to change the second region of the first image depending on an amount of the time variation when the time variation reaches a first predetermined threshold. The present disclosure also provides an electronic device.

### PRIORITY APPLICATIONS

This application claims the benefit of priority under 35 U.S.C. 119 to Chinese Application No 201410153254.7, filed on 16 Apr. 2014; which application is incorporated herein by reference in its entirety.

### TECHNICAL FIELD

The present disclosure relates to electronic technology, and more particularly, to an information processing method and an electronic device.

### BACKGROUND

With the prevalence of consumer electronic products, users become more and more dependent on electronic devices such as mobile phones. These electronic devices have become necessary tools in our lives. A number of applications are installed in an electronic device. Such applications generally need to be displayed on a display unit of the electronic device.

### SUMMARY

It is an object of the present disclosure to provide an information processing method and an electronic device.

In a first aspect, an information processing method is provided. The method is applied in an electronic device including a display unit and a first controller and having a first application installed thereon. The method comprises: displaying a first image of the first application on the display unit of the electronic device while the first application is running, the first image including a first region and a second region; detecting a time variation and changing the first region of the first image in response to the time variation; and activating the first controller to change the second region of the first image depending on an amount of the time variation after the time variation reaches a first predetermined threshold.

In an embodiment, the first region of the first image is changed per time unit, and the step of detecting the time variation and changing the first region of the first image in response to the time variation comprises: retrieving, during the i-th time unit, the i-th first buffered image data corresponding to the i-th time unit and writing the i-th first buffered image data into the first region, where i denotes an index.

In an embodiment, the electronic device further comprises a second controller and a real-time clock configured to issue a first interruption command per time unit, and the step of detecting the time variation and changing the first region of the first image in response to the time variation comprises: detecting the i-th first interruption command issued by the real-time clock in the i-th time unit; retrieving, in response to the i-th first interruption command, the i-th first buffered image data corresponding to the i-th time unit using the second controller; and writing the i-th first buffered image data into the first region, where i denotes an index.

In an embodiment, the electronic device further comprises a real-time clock configured to issue a first interruption command per time unit, and the first threshold comprises M time units, and the step of activating the first controller to change the second region of the first image depending on an amount of the time variation after the time variation reaches the first predetermined threshold comprises: detecting the i-th first interruption command issued by the real-time clock in the i-th time unit; retrieving, when it is determined that i is equal to M, the second buffered image data in response to the M-th first interruption command using the first controller; and controlling the second controller to write the second buffered image data into the second region.

In an embodiment, the second controller has a memory comprising a first memory area for storing the first buffered image data and a second memory area for storing the second buffered image data.

In an embodiment, the first application is a clock application displaying variations of a second hand, the time unit is one second, and the first threshold is 60 seconds, the real-time clock is configured to issue a first interruption command per second, and the first buffered image data comprises buffered data displayed for 0 to 59 seconds.

In an embodiment, the real-time clock of the electronic device comprises a first real-time clock, the first real-time clock being a real-time clock within the first controller and being connected to the first controller, or the real-time clock of the electronic device comprises the first real-time clock and an additional second real-time clock that is connected to the first controller.

In a second aspect, an electronic device is provided. The electronic device includes a display unit and a first controller and has a first application installed thereon. The electronic device comprises: a displaying unit configured to display a first image of the first application while the first application is running, the first image including a first region and a second region; a first changing unit configured to detect a time variation and change the first region of the first image in response to the time variation; and a second changing unit configured to activate the first controller to change the second region of the first image depending on an amount of the time variation after the time variation reaches a first predetermined threshold.

In an embodiment, the first region of the first image is changed per time unit, and the first changing unit is configured to retrieve, during the i-th time unit, the i-th first buffered image data corresponding to the i-th time unit and write the i-th first buffered image data into the first region, where i denotes an index.

In an embodiment, the electronic device further comprises a second controller and a real-time clock configured to issue a first interruption command per time unit, wherein the first changing unit comprises: a first detecting module configured to detect the i-th first interruption command issued by the real-time clock in the i-th time unit; a first retrieving module configured to retrieve, in response to the i-th first interruption command, the i-th first buffered image data corresponding to the i-th time unit using the second controller; and a first writing module configured to write the i-th first buffered image data into the first region, where i denotes an index.

In an embodiment, the electronic device further comprises a real-time clock configured to issue a first interruption command per time unit, wherein the first threshold comprises M time units, and the second changing unit comprises: a first detecting module configured to detect the i-th first interruption command issued by the real-time clock in the i-th time unit; a second retrieving unit configured to retrieve, when it is determined that i is equal to M, the second buffered image data in response to the M-th first interruption command using the first controller; and a second writing module configured to control the second controller to write the second buffered image data into the second region using the first controller.

In an embodiment, the second controller has a memory comprising a first memory area for storing the first buffered image data and a second memory area for storing the second buffered image data.

In an embodiment, the first application is a clock application displaying variations of a second hand, the time unit is one second, and the first threshold is 60 seconds, the real-time clock is configured to issue a first interruption command per second, and the first buffered image data comprises buffered data displayed for 0 to 59 seconds.

In an embodiment, the real-time clock of the electronic device comprises a first real-time clock, the first real-time clock being a real-time clock within the first controller and being connected to the first controller, or the real-time clock of the electronic device comprises the first real-time clock and an additional second real-time clock that is connected to the first controller.

In the embodiments of the present disclosure, a first image of the first application is displayed on the display unit of the electronic device while the first application is running. The first image includes a first region and a second region. A time variation is detected and the first region of the first image is changed in response to the time variation. After the time variation reaches a first predetermined threshold, the first controller is activated to change the second region of the first image depending on an amount of the time variation. In this way, it is possible to save memory, improve operation efficiency and reduce power consumption while displaying.

### BRIEF DESCRIPTION OF THE DRAWINGS

FIG. 1A is a flowchart illustrating an information processing method according to a first embodiment of the present disclosure;

FIG. 1B is a first schematic diagram showing a relation between a first region and a second region according to the first embodiment of the present disclosure;

FIG. 1C is a second schematic diagram showing a relation between a first region and a second region according to the first embodiment of the present disclosure;

FIG. 1D is a third schematic diagram showing a relation between a first region and a second region according to the first embodiment of the present disclosure;

FIG. 2 is a flowchart illustrating an information processing method according to a second embodiment of the present disclosure;

FIG. 3A is a flowchart illustrating an information processing method according to a third embodiment of the present disclosure;

FIG. 3B is a schematic diagram showing the numbers of times a GPU is woken with and without application of the third embodiment of the present disclosure;

FIG. 3C is a first schematic diagram showing a division of a memory of a second controller according to the third embodiment of the present disclosure;

FIG. 3D is a second schematic diagram showing a division of a memory of a second controller according to the third embodiment of the present disclosure;

FIG. 3E is a first schematic diagram showing connectivity between a real-time clock and a first controller or the second controller according to the third embodiment of the present disclosure;

FIG. 3F is a schematic diagram showing connectivity between a real-time clock and a first controller or the second controller according to an embodiment of the present disclosure;

FIG. 3G is a second schematic diagram showing connectivity between a real-time clock and a first controller or the second controller according to the third embodiment of the present disclosure;

FIG. 4 is a flowchart illustrating an information processing method according to a fourth embodiment of the present disclosure;

FIG. 5A is a flowchart illustrating an information processing method according to a fifth embodiment of the present disclosure;

FIG. 5B is a schematic diagram showing a display interface when a clock application is running according to the fifth embodiment of the present disclosure;

FIG. 6 is a schematic diagram showing a structure of an electronic device according to a sixth embodiment of the present disclosure;

FIG. 7 is a schematic diagram showing a structure of an electronic device according to a seventh embodiment of the present disclosure; and

FIG. 8 is a schematic diagram showing a structure of an electronic device according to an eighth embodiment of the present disclosure.

### DETAILED DESCRIPTION OF THE EMBODIMENTS

The solutions of the present disclosure will be further detailed with reference to the figures and embodiments.

### 1^{st} Embodiment

According to this embodiment, an information processing method is provided. The method is applied in an electronic device including a display unit and a first controller and having a first application installed thereon.

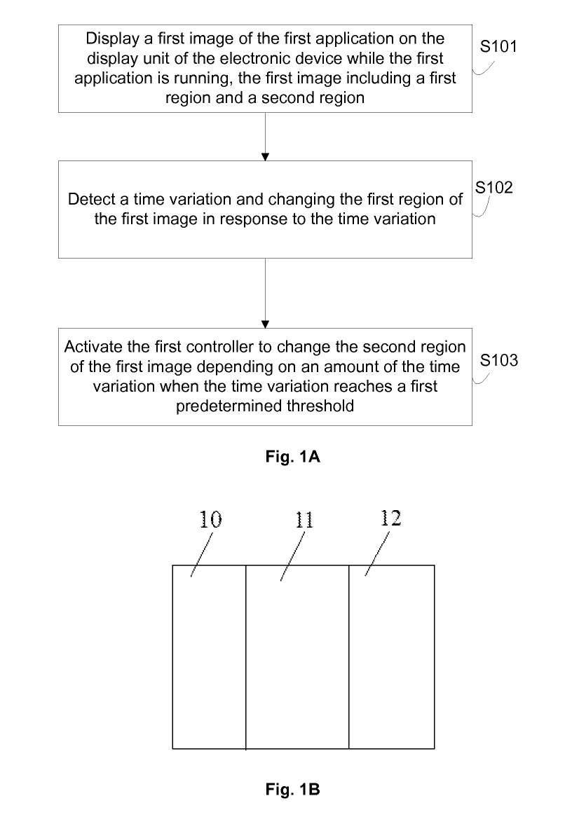

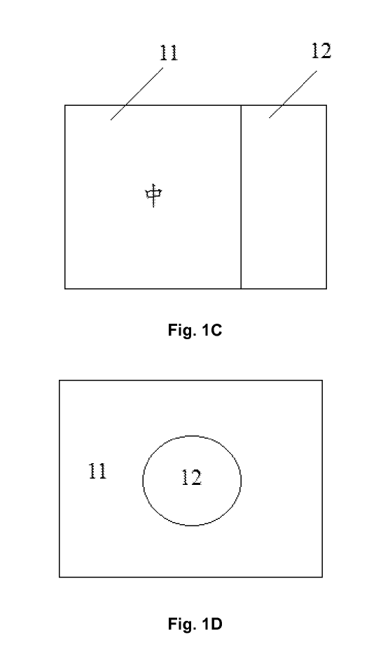

FIG. 1-1 is a flowchart illustrating an information processing method according to the first embodiment of the present disclosure. As shown in FIG. 1-1, the method includes the following steps.

At step S101, a first image of the first application is displayed on the display unit of the electronic device while the first application is running. The first image includes a first region and a second region.

Here, the electronic device can be a mobile phone, a tablet computer, a notebook computer or an e-reader.

Here, the first application can be any application having a display interface displayed on the display unit of the electronic device as the first image. The first application can be a game application, a clock application or an application for displaying advertisements, etc.

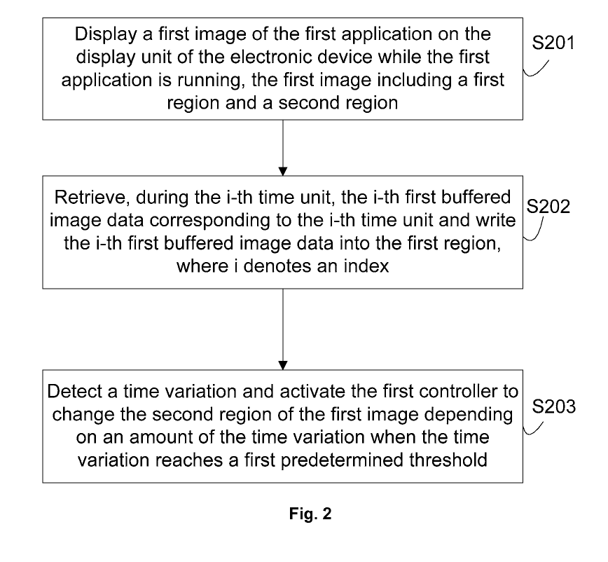

Here, as shown in FIG. 1-2, the first image includes an invariant region 10, a first region 11 and a second region 12. The content in the invariant region 10 does not vary. The content in the first region 11 varies at a certain frequency or period and the content in the second region 12 varies at another frequency or period. As shown in FIGS. 1-3 and 1-4, the first image includes the first region 11 and the second region 12. The second region 12 is the region other than the first region 11 in the first image. FIGS. 1-3 and 1-4 differ from each other in that, in FIG. 1-3, the first region 11 and the second region 12 are combined to form the first image of the first application, whereas in FIG. 1-4, the second region 12 is surrounded by the first region 11. Alternatively, the first region 11 can be surrounded by the second region 12, which is not shown here for simplicity.

At step S102, a time variation is detected and the first region of the first image is changed in response to the time variation.

At step S103, after the time variation reaches a first predetermined threshold, the first controller is activated to change the second region of the first image depending on an amount of the time variation.

Here, the time variation can be detected as follows. For example, the current time can be obtained and the time variation can be detected when the current time is identical to a defined time threshold. At this time, the first region of the first image is changed. It is to be noted that the electronic device typically includes at least one real-time clock, which can be implemented by a crystal oscillator circuit. Hence, in an embodiment of the present disclosure, the time variation can be detected by obtaining the time variation of the crystal oscillator. It can be appreciated by those skilled in the art that the time variation can be detected using any of various existing techniques and the description thereof will be omitted here for simplicity.

Here, the first region of the first image can be changed by the first controller in response to the time variation. For example, after the time variation reaches a defined time threshold, the first controller can be activated to change the first region. Alternatively, the changing operation can be performed by another controller, e.g., a second controller. After the time variation reaches a defined time threshold, the second controller can be activated to change the first region. It can be appreciated by those skilled in the art that the first region of the first image can be changed using any of other techniques and the description thereof will be omitted here for simplicity.

The solution according to this embodiment can be applied in the following scenario. As an example, the first application is an application for presenting advertisements. At the time 00:00:00, the display content of the first image of the first application is a Chinese character “ [symbol] ”, as shown in FIG. 1-3. At the time 00:00:40, the display content of the first image of the first application is changed into a Chinese character “ [symbol] ”. That is, the character “ [symbol] ” has been displayed for 40 seconds. At the time 00:01:00, the display content is changed into a Chinese character “ [symbol] ”. That is, the character “ [symbol] ” has been displayed for 20 seconds. At the time 00:01:20, the display content is changed into a Chinese character “ [symbol] ”. That is, the character “ [symbol] ” has been displayed for 20 seconds. Then, at the time 00:01:40, the display content is changed into a Chinese character “ [symbol] ”. That is, the character “ [symbol] ” has been displayed for 20 seconds. In this way, during the period from 00:00:00 to 00:01:39, the Chinese characters “ [symbol] ” have been displayed sequentially. Conventionally, the first image of the first application is changed entirely over time, i.e., the entire first image is changed each time the content of the first image is changed (i.e., at 00:00:00, 00:00:40, 00:01:00 and 00:01:20), without dividing the first image into two regions. In contrast, with the embodiment of the present disclosure, the first image is first divided into at least two regions depending on the frequencies or periods at which their respective contents are changed. Then, only the content in the first region 11 needs to be changed each time the content of the first image is changed (i.e., at 00:00:00, 00:00:40, 00:01:00 and 00:01:20), without changing the content in the second region 12.

In the embodiment of the present disclosure, a first image of the first application is displayed on the display unit of the electronic device while the first application is running. The first image includes a first region and a second region. A time variation is detected and the first region of the first image is changed in response to the time variation. After the time variation reaches a first predetermined threshold, the first controller is activated to change the second region of the first image depending on an amount of the time variation. Thus, the first image to be displayed for the first application can be divided into different regions depending on the frequencies or periods at which their respective contents are changed. The content in each region can be changed individually when it needs to be changed. In this way, it is possible to save memory, improve operation speed and improve user experience.

### 2^{nd} Embodiment

According to this embodiment, an information processing method is provided. The method is applied in an electronic device including a display unit and a first controller and having a first application installed thereon.

FIG. 2 is a flowchart illustrating an information processing method according to the second embodiment of the present disclosure. As shown in FIG. 2, the method includes the following steps.

At step S201, a first image of the first application is displayed on the display unit of the electronic device while the first application is running. The first image includes a first region and a second region.

Here, the first region of the first image can be changed per time unit.

Here, the first application can be any application having a display interface displayed on the display unit of the electronic device as the first image. The first application can be a game application, a clock application or an application for displaying advertisements, etc.

Here, as shown in FIG. 1-2, the first image includes an invariant region 10, a first region 11 and a second region 12. The content in the first region 11 varies at a certain frequency or period and the content in the second region 12 varies at another frequency or period. As shown in FIGS. 1-3 and 1-4, the first image includes the first region 11 and the second region 12. The second region 12 is the region other than the first region 11 in the first image. FIGS. 1-3 and 1-4 differ from each other in that, in FIG. 1-3, the first region 11 and the second region 12 are combined to form the first image of the first application, whereas in FIG. 1-4, the second region 12 is surrounded by the first region 11. Alternatively, the first region 11 can be surrounded by the second region 12, which is not shown here for simplicity.

At step S202, during the i-th time unit, the i-th first buffered image data corresponding to the i-th time unit is retrieved and the i-th first buffered image data is written into the first region, where i denotes an index.

At step S203, a time variation is detected and, after the time variation reaches a first predetermined threshold, the first controller is activated to change the second region of the first image depending on an amount of the time variation.

The solution according to this embodiment can be applied in the following scenario. Further to the example given in the first embodiment where the first application is an application for presenting advertisements, at the time 00:00:00, the display content of the first image of the first application is a Chinese character “ [symbol] ”, as shown in FIG. 1-3. At the time 00:00:20, the display content of the first image of the first application is changed into a Chinese character “ [symbol] ”. That is, the character “ [symbol] ” has been displayed for 20 seconds. At the time 00:00:40, the display content is changed into a Chinese character “ [symbol] ”. That is, the character “ [symbol] ” has been displayed for 20 seconds. At the time 00:01:00, the display content is changed into a Chinese character “ [symbol] ”. That is, the character “ [symbol] ” has been displayed for 20 seconds. Then, at the time 00:01:20, the display content is changed into a Chinese character “ [symbol] ”. That is, the character “ [symbol] ” has been displayed for 20 seconds. In this way, during the period from 00:00:00 to 00:01:19, the Chinese characters “ [symbol] ” have been displayed sequentially. Conventionally, the first image of the first application is changed entirely over time, i.e., the entire first image is changed each time the content of the first image is changed (i.e., at 00:00:00, 00:00:20, 00:00:40 and 00:01:20), without dividing the first image into two regions. In contrast, with the embodiment of the present disclosure, the first image is first divided into at least two regions depending on the frequencies or periods at which their respective contents are changed. Then, only the content in the first region 11 needs to be changed each time the content of the first image is changed (i.e., at 00:00:00, 00:00:20, 00:00:40 and 00:01:00), without changing the content in the second region 12.

In this embodiment, the first region of the first image is changed per time unit. In the above example, the content in the first region is changed every 20 seconds. In an implementation, a circuit for generating time units, e.g., a crystal oscillator circuit issuing a pulse signal every 20 seconds, can be incorporated into the electronic device and the content in the first region can be changed in response to obtaining such signal. It can be appreciated by those skilled in the art that the changing of the first region per time unit can be implemented in other ways, which will not be detailed here for simplicity.

### 3^{rd} Embodiment

According to this embodiment, an information processing method is provided. The method is applied in an electronic device including a display unit, a real-time clock, a first controller and a second controller and having a first application installed thereon. The real-time clock is configured to issue a first interruption command per time unit.

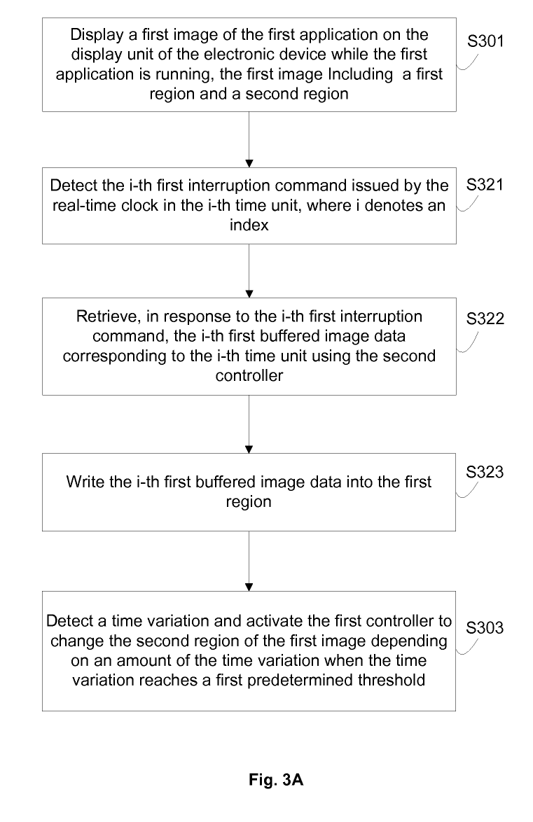

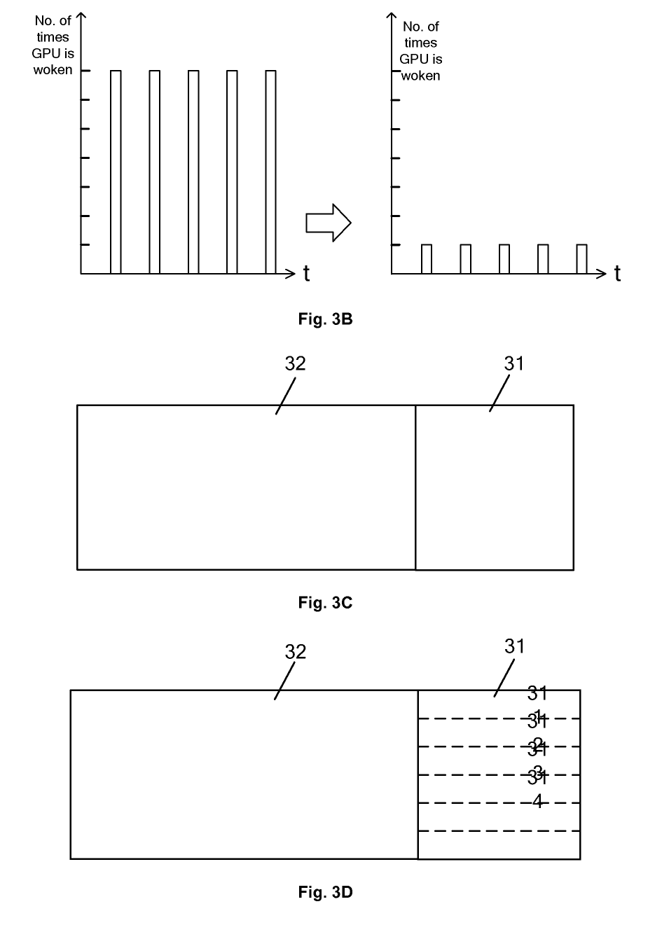

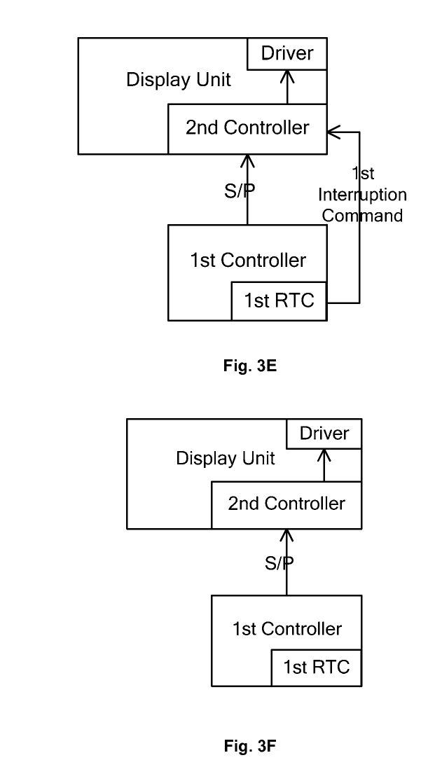

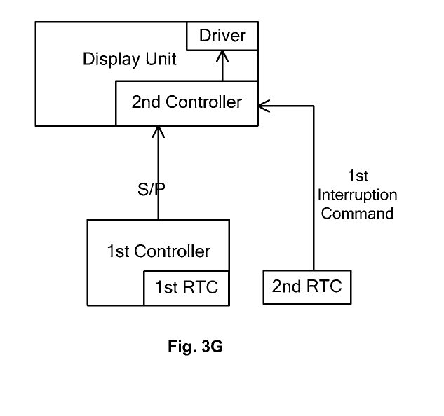

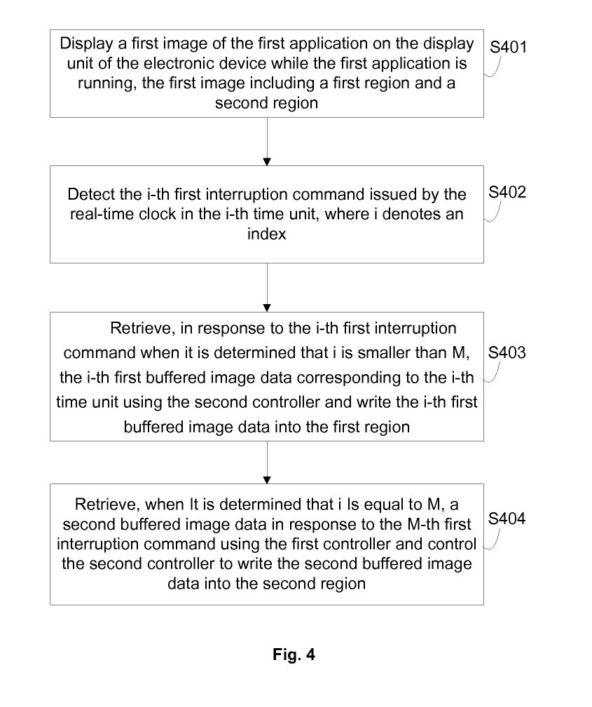

FIG. 3-1 is a flowchart illustrating an information processing method according to the third embodiment of the present disclosure. As shown in FIG. 3-1, the method includes the following steps.

At step S301, a first image of the first application is displayed on the display unit of the electronic device while the first application is running. The first image includes a first region and a second region.

Here, the first application can be any application having a display interface displayed on the display unit of the electronic device as the first image. The first application can be a game application, a clock application or an application for displaying advertisements, etc.

Here, the real-time clock (RTC) is a series of pulses generated by a clock circuit consisting of a crystal oscillator and related circuits (referred to as crystal oscillator circuit) in a main board of the electronic device. These pulses can be used for generating a system clock. It can be understood by those skilled in the art and the details thereof will be omitted here.

At step S321, the i-th first interruption command issued by the real-time clock in the i-th time unit is detected, where i denotes an index.

Here, the first interruption command can be a pulse signal generated by the RTC.

At step S322, in response to the i-th first interruption command, the i-th first buffered image data corresponding to the i-th time unit is retrieved using the second controller.

At step S323, the i-th first buffered image data is written into the first region.

At step S303, a time variation is detected and, after the time variation reaches a first predetermined threshold, the first controller is activated to change the second region of the first image depending on an amount of the time variation.

In this embodiment, the operations of changing the contents in the first and second regions are performed by two different controllers, respectively, i.e., the first region is changed by the second controller, while the second region is changed by the first controller. In an implementation, the first controller can be a Graphic Processing Unit (GPU), which can be implemented by a Micro Control Unit (MCU) or a single chip machine, or an Accelerated Processing Unit (APU). When the first controller is a GPU, the second controller can be a display controller, e.g., a Liquid Crystal Display (LCD) controller.

Here, the LCD controller can provide the electronic device with a continuous display data stream; otherwise the electronic device can display no image or distorted images. The LCD controller can be implemented by an MCU or a display memory, etc.

Here, in the example where the first controller is a GPU and the second controller is a LCD controller, the step S303 of activating the first controller to change the second region of the first image includes activating the GPU to control the LCD controller to change the second region of the first image.

The technical effects of the embodiment of the present disclosure will be described with reference to the example where the first controller is a GPU and the second controller is a LCD controller. When the first application is running on the electronic device, the display interface is continuously updated over time. In order to update the display interface, the first application continuously wakes the GPU. Then, the GPU stores the content to be displayed in a memory of the LCD controller in a form of buffered image data, such that the LCD controller can read and display the buffered image data on the display unit. Conventionally, in doing so, the GPU is continuously woken to switch the display interface of the first application. In contrast, with the solution according to the embodiment of the present disclosure, the first image to be displayed for the first application is first divided into different regions, i.e., the first region and the second region, depending on frequencies or periods at which they are changed. The frequency at which the first region is changed is relatively high and the frequency at which the second region is changed is relatively low. Then, the LCD controller changes the first region in response to the first interruption command issued by the real-time clock. Finally, the GPU changes the second region. It can be seen that, when the first application switches the display interface, the GPU does not need to be woken each time the display interface is changed; rather, it only needs to be woken when the second region is to be changed. As shown in FIG. 3-2, the first graph in FIG. 3-2 shows the number of times the GPU is woken in the conventional solution, while the second graph in FIG. 3-2 shows the number of times the GPU is woken in the solution according to this embodiment. Hence, with the solution according to this embodiment, the number of times the display controller is woken can be effectively reduced, thereby reducing the power consumption of the electronic device and increasing the battery lifetime of the electronic device.

In the embodiment of the present disclosure, as shown in FIGS. 3-3 and 3-4, the memory of the second controller includes a first memory area 31 for storing the first buffered image data and a second memory area 32 for storing the second buffered image data. Here, as shown in FIG. 3-4, the first memory area 31 can be further divided into a number of memory area blocks, such as memory area blocks 311-314. The sizes of the respective memory region blocks can be the same or different. It can be appreciated by those skilled in the art that the second memory region can be divided into memory area blocks in any of various existing techniques and the description thereof will be omitted here.

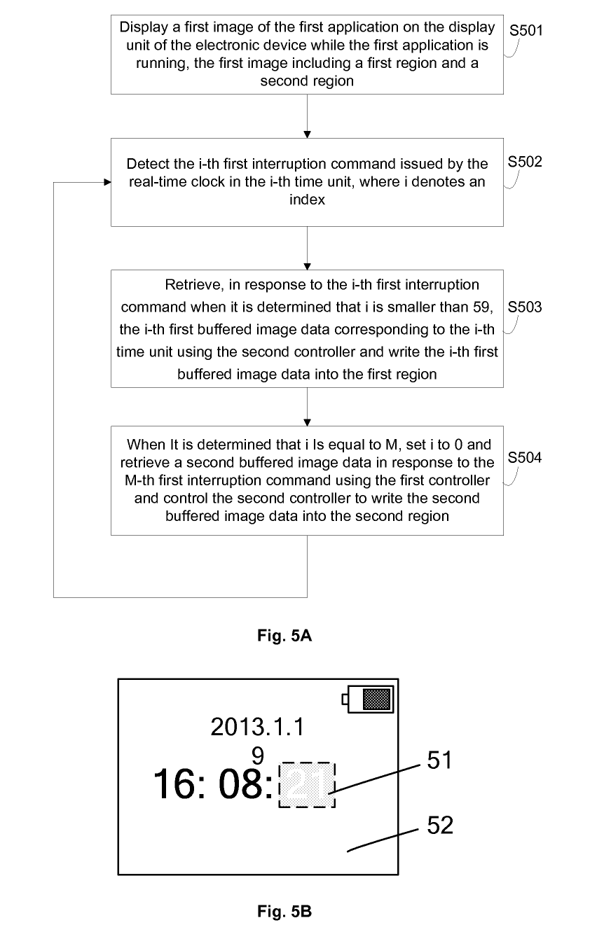

In an embodiment of the present disclosure, the electronic device can include one RTC, i.e., the first RTC. As shown in FIG. 5, the first RTC is an RTC within the first controller and is connected to the second controller, such that the first RTC can issue a first interruption command to the second controller. FIG. 3-6 shows a related solution. The solution shown in FIG. 3-5 differs from the solution shown in FIG. 3-6 in that the first RTC needs to be connected to the second controller.

In an embodiment of the present disclosure, the electronic device can include two RTCs, i.e., a first RTC and an additional second RTC as shown in FIG. 3-7. The additional second RTC is connected to the second controller. The first and second RTCs may have the same clock frequency, or different clock frequencies. It can be understood by those skilled in the art and the details thereof will be omitted here.

### 4^{th} Embodiment

Based on the above first to third embodiments, according to this embodiment, an information processing method is provided. The method is applied in an electronic device including a display unit, a real-time clock, a first controller and a second controller and having a first application installed thereon. The real-time clock is configured to issue a first interruption command per time unit. A first threshold includes M time units. FIG. 4 is a flowchart illustrating an information processing method according to the fourth embodiment of the present disclosure. As shown in FIG. 4, the method includes the following steps.

At step S401, a first image of the first application is displayed on the display unit of the electronic device while the first application is running. The first image includes a first region and a second region.

Here, the first application can be any application having a display interface displayed on the display unit of the electronic device as the first image. The first application can be a game application, a clock application or an application for displaying advertisements, etc.

Here, the real-time clock (RTC) is a series of pulses generated by a clock circuit consisting of a crystal oscillator circuit in a main board of the electronic device. These pulses can be used for generating a system clock. It can be understood by those skilled in the art and the details thereof will be omitted here.

At step S402, the i-th first interruption command issued by the real-time clock in the i-th time unit is detected, where i denotes an index.

At step S403, when it is determined that i is smaller than M, the i-th first buffered image data corresponding to the i-th time unit is retrieved in response to the i-th first interruption command and written into the first region using the second controller.

A step S404, when it is determined that i is equal to M, the second buffered image data is retrieved in response to the M-th first interruption command using the first controller, and the first controller controls the second controller to write the second buffered image data into the second region.

In the embodiment of the present disclosure, as shown in FIGS. 3-3 and 3-4, the memory of the second controller includes a first memory area 31 for storing the first buffered image data and a second memory area 32 for storing the second buffered image data. Here, as shown in FIG. 3-4, the first memory area 31 can be further divided into a number of memory area blocks, such as memory area blocks 311-314.

In an embodiment of the present disclosure, the electronic device can include one RTC, i.e., the first RTC. As shown in FIG. 5, the first RTC is an RTC within the first controller and is connected to the second controller, such that the first RTC can issue a first interruption command to the second controller. Alternatively, the electronic device can include two RTCs, i.e., a first RTC and an additional second RTC as shown in FIG. 3-7. The additional second RTC is connected to the second controller. It is to be noted here that the first and second RTCs should have the same clock frequency.

### 5^{th} Embodiment

With the prevalence of consumer electronic products, users become more and more dependent on electronic devices such as mobile phones. These electronic devices have taken the place of watches as timing tools. However, the operation of an electronic device is dependent on its battery. Hence, the battery is very important to the electronic device. Given the capacity of the battery, the manufacture of the electronic device desires to reduce the power consumption, thereby increasing the battery lifetime.

According to this embodiment, an information processing method is provided. The method is applied in an electronic device including a display unit, a real-time clock, a first controller and a second controller. The real-time clock is configured to issue a first interruption command per time unit. The electronic device has a clock application installed thereon. When executed, the clock application displays a clock involving variations of its hour hand, minute hand and second hand. Accordingly, the time unit is one second and the real-time clock issues a first interruption command per second.

FIG. 5-1 is a flowchart illustrating an information processing method according to the fifth embodiment of the present disclosure. As shown in FIG. 5-1, the method includes the following steps.

At step S501, a first image of the clock application is displayed on the display unit of the electronic device while the clock application is running. The first image includes a first region and a second region.

Here, the first application can be any application having a display interface displayed on the display unit of the electronic device as the first image. The first application can be a game application, a clock application or an application for displaying advertisements, etc.

Here, the real-time clock (RTC) is a series of pulses generated by a clock circuit consisting of a crystal oscillator circuit in a main board of the electronic device. These pulses can be used for generating a system clock. It can be understood by those skilled in the art and the details thereof will be omitted here.

At step S502, the i-th first interruption command issued by the real-time clock in the i-th time unit is detected, where i denotes an index.

At step S503, when it is determined that i is smaller than or equal to 59, the i-th first buffered image data corresponding to the i-th time unit is retrieved in response to the i-th first interruption command and written into the first region using the second controller.

Here, the i-th first buffered image data corresponds to the first buffered image data for the i-th second.

A step S504, when it is determined that i is equal to 60, i is set to zero and the second buffered image data is retrieved in response to the 0-th first interruption command using the first controller, and the first controller controls the second controller to write the second buffered image data into the second region. Then the method returns to the step S502.

The embodiment of the present disclosure can be applied in the following scenario. FIG. 5-2 is a schematic diagram showing a display interface when a clock application is running according to the fifth embodiment of the present disclosure. As shown in FIG. 5-2, conventionally the RTC is used for timing. The RTC interrupts the first controller by issuing the first interruption command per second. The first controller is woken to update the content to be displayed. Then, the second controller reads the buffered image data and updates the clock. In fact, during one minute, only the content in the gray region, i.e., the first region 51 representing the variation of the second hand in FIG. 5-2 is changed, while the second region 52 other than the first region 51 is not changed from 00 to 59 seconds. With the solution according to the embodiment of the present disclosure, the first controller is woken once every minute. When compared with the conventional solution where the first controller has to be woken for 60 times every minute, the solution according to the embodiment of the present disclosure can effectively reduce the number of times the first controller is woken, thereby reducing the power consumption of the electronic device and increasing the battery lifetime of the electronic device.

In the embodiment of the present disclosure, as shown in FIGS. 3-3 and 3-4, the memory of the second controller includes a first memory area 31 for storing the first buffered image data and a second memory area 32 for storing the second buffered image data. The first memory area 31 can be further divided into 59 memory area blocks for storing the buffered image data for 1 to 59 seconds, respectively.

In an embodiment of the present disclosure, the electronic device can include one RTC, i.e., the first RTC. As shown in FIG. 3-5, the first RTC is an RTC within the first controller and is connected to the second controller, such that the first RTC can issue a first interruption command to the second controller. Alternatively, the electronic device can include two RTCs, i.e., a first RTC and an additional second RTC as shown in FIG. 3-7. The additional second RTC is connected to the second controller. It is to be noted here that the first and second RTCs should have the same clock frequency.

### 6^{th} Embodiment

According to this embodiment, an electronic device is provided. The electronic device includes a display unit and a first controller and has a first application installed thereon.

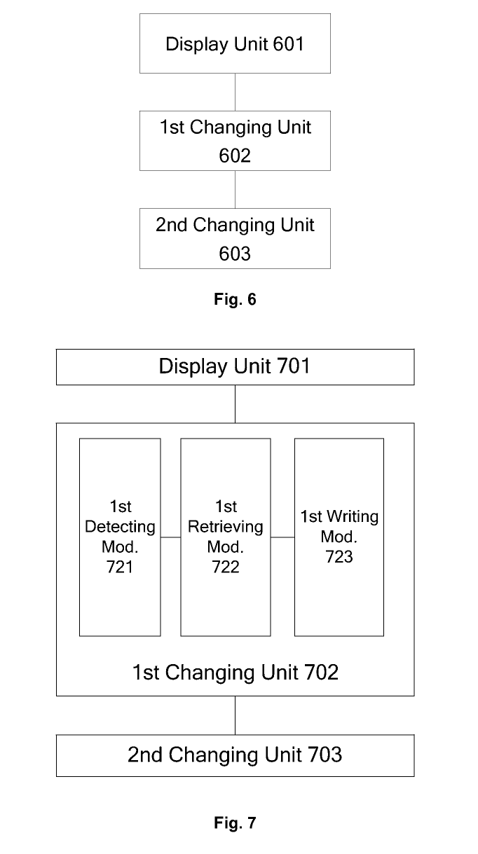

FIG. 6 is a schematic diagram showing a structure of an electronic device according to a sixth embodiment of the present disclosure. As shown in FIG. 6, the electronic device includes a display unit 601, a first changing unit 602 and a second changing unit 603.

The displaying unit 601 is configured to display a first image of the first application while the first application is running. The first image includes a first region and a second region.

Here, the electronic device can be a mobile phone, a tablet computer, a notebook computer or an e-reader, etc.

Here, the first application can be any application having a display interface displayed on the display unit of the electronic device as the first image. The first application can be a game application, a clock application or an application for displaying advertisements, etc.

Here, as shown in FIG. 1-2, the first image includes an invariant region 10, a first region 11 and a second region 12. The content in the invariant region 10 does not vary. The content in the first region 11 varies at a certain frequency or period and the content in the second region 12 varies at another frequency or period. As shown in FIGS. 1-3 and 1-4, the first image includes the first region 11 and the second region 12. The second region 12 is the region other than the first region 11 in the first image. FIGS. 1-3 and 1-4 differ from each other in that, in FIG. 1-3, the first region 11 and the second region 12 are combined to form the first image of the first application, whereas in FIG. 1-4, the second region 12 is surrounded by the first region 11. Alternatively, the first region 11 can be surrounded by the second region 12, which is not shown here for simplicity.

The first changing unit 602 is configured to detect a time variation and change the first region of the first image in response to the time variation.

The second changing unit 603 is configured to activate the first controller to change the second region of the first image depending on an amount of the time variation after the time variation reaches a first predetermined threshold.

Here, the time variation can be detected as follows. For example, the current time can be obtained and the time variation can be detected when the current time is identical to a defined time threshold. At this time, the first region of the first image is changed. It is to be noted that the electronic device typically includes at least one real-time clock, which can be implemented by a crystal oscillator circuit. Hence, in an embodiment of the present disclosure, the time variation can be detected by obtaining the time variation of the crystal oscillator. It can be appreciated by those skilled in the art that the time variation can be detected using any of various existing techniques and the description thereof will be omitted here.

Here, the first region of the first image can be changed by the first controller in response to the time variation. For example, after the time variation reaches a defined time threshold, the first controller can be activated to change the first region. Alternatively, the changing operation can be performed by another controller, e.g., a second controller. After the time variation reaches a defined time threshold, the second controller can be activated to change the first region. It can be appreciated by those skilled in the art that the first region of the first image can be changed using any of various existing techniques and the description thereof will be omitted here.

The solution according to this embodiment can be applied in the following scenario. As an example, the first application is an application for presenting advertisements. At the time 00:00:00, the display content of the first image of the first application is a Chinese character “ [symbol] ”, as shown in FIG. 1-3. At the time 00:00:40, the display content of the first image of the first application is changed into a Chinese character “ [symbol] ”. That is, the character “ [symbol] ” has been displayed for 40 seconds. At the time 00:01:00, the display content is changed into a Chinese character “ [symbol] ”. That is, the character “ [symbol] ” has been displayed for 20 seconds. At the time 00:01:20, the display content is changed into a Chinese character “ [symbol] ”. That is, the character “ [symbol] ” has been displayed for 20 seconds. Then, at the time 00:01:40, the display content is changed into a Chinese character “ [symbol] ”. That is, the character “ [symbol] ” has been displayed for 20 seconds. In this way, during the period from 00:00:00 to 00:01:39, the Chinese characters “ [symbol] ” have been displayed sequentially. Conventionally, the first image of the first application is changed entirely over time, i.e., the entire first image is changed each time the content of the first image is changed (i.e., at 00:00:00, 00:00:40, 00:01:00 and 00:01:20), without dividing the first image into two regions. In contrast, with the embodiment of the present disclosure, the first image is first divided into at least two regions depending on the frequencies or periods at which their respective contents are changed. Then, only the content in the first region 11 needs to be changed each time the content of the first image is changed (i.e., at 00:00:00, 00:00:40, 00:01:00 and 00:01:20), without changing the content in the second region 12.

In the embodiment of the present disclosure, a first image of the first application is displayed on the display unit of the electronic device while the first application is running. The first image includes a first region and a second region. A time variation is detected and the first region of the first image is changed in response to the time variation. After the time variation reaches a first predetermined threshold, the first controller is activated to change the second so region of the first image depending on an amount of the time variation. Thus, the first image to be displayed for the first application can be divided into different regions depending on the frequencies or periods at which their respective contents are changed. The content in each region can be changed individually when it needs to be changed. In this way, it is possible to save memory, improve operation speed and improve user experience.

### 7^{th} Embodiment

According to this embodiment, an electronic device is provided. The electronic device includes a display unit and a first controller and has a first application installed thereon.

The electronic device includes a display unit, a first changing unit and a second changing unit.

The displaying unit is configured to display a first image of the first application while the first application is running. The first image includes a first region and a second region. The first region of the first image is changed per time unit.

The first changing unit is configured to retrieve, during the i-th time unit, the i-th first buffered image data corresponding to the i-th time unit and write the i-th first buffered image data into the first region, where i denotes an index.

The second changing unit is configured to detect a time variation and activate the first controller to change the second region of the first image depending on an amount of the time variation after the time variation reaches a first predetermined threshold.

The solution according to this embodiment can be applied in the following scenario. Further to the example given in the first embodiment where the first application is an application for presenting advertisements, at the time 00:00:00, the display content of the first image of the first application is a Chinese character “ [symbol] ”, as shown in FIG. 1-3. At the time 00:00:20, the display content of the first image of the first application is changed into a Chinese character “ [symbol] ”. That is, the character “ [symbol] ” has been displayed for 20 seconds. At the time 00:00:40, the display content is changed into a Chinese character “ [symbol] ”. That is, the character “ [symbol] ” has been displayed for 20 seconds. At the time 00:01:00, the display content is changed into a Chinese character “ [symbol] ”. That is, the character “ [symbol] ” has been displayed for 20 seconds. Then, at the time 00:01:20, the display content is changed into a Chinese character “ [symbol] ”. That is, the character “ [symbol] ” has been displayed for 20 seconds. In this way, during the period from 00:00:00 to 00:01:19, the Chinese characters “ [symbol] ” have been displayed sequentially. Conventionally, the first image of the first application is changed entirely over time, i.e., the entire first image is changed each time the content of the first image is changed (i.e., at 00:00:00, 00:00:20, 00:00:40 and 00:01:20), without dividing the first image into two regions. In contrast, with the embodiment of the present disclosure, the first image is first divided into at least two regions depending on the frequencies or periods at which their respective contents are changed. Then, only the content in the first region 11 needs to be changed each time the content of the first image is changed (i.e., at 00:00:00, 00:00:20, 00:00:40 and 00:01:00), without changing the content in the second region 12.

In this embodiment, the first region of the first image is changed per time unit. In the above example, the content in the first region is changed every 20 seconds. In an implementation, a circuit for generating time units, e.g., a crystal oscillator circuit issuing a pulse signal every 20 seconds, can be incorporated into the electronic device and the content in the first region can be changed in response to obtaining such signal. It can be appreciated by those skilled in the art that the changing of the first region per time unit can be implemented in other ways, which will not be detailed here.

### 8^{th} Embodiment

According to this embodiment, an electronic device is provided. The electronic device includes a display unit, a real-time clock, a first controller and a second controller and has a first application installed thereon. The real-time clock is configured to issue a first interruption command per time unit.

FIG. 7 is a schematic diagram showing a structure of an electronic device according to an eighth embodiment of the present disclosure. As shown in FIG. 7, the electronic device includes a display unit 701, a first changing unit 702 and a second changing unit 703. The first changing unit 702 includes a first detecting module 721, a first retrieving module 722 and a first writing module 723.

The displaying unit 701 is configured to display a first image of the first application on the display unit of the electronic device while the first application is running. The first image includes a first region and a second region.

Here, the first region of the first image is changed per time unit.

Here, the first application can be any application having a display interface displayed on the display unit of the electronic device as the first image. The first application can be a game application, a clock application or an application for displaying advertisements, etc.

Here, as shown in FIG. 1-2, the first image includes an invariant region 10, a first region 11 and a second region 12. The content in the first region 11 varies at a certain frequency or period and the content in the second region 12 varies at another frequency or period. As shown in FIGS. 1-3 and 1-4, the first image includes the first region 11 and the second region 12. The second region 12 is the region other than the first region 11 in the first image. FIGS. 1-3 and 1-4 differ from each other in that, in FIG. 1-3, the first region 11 and the second region 12 are combined to form the first image of the first application, whereas in FIG. 1-4, the second region 12 is surrounded by the first region 11. Alternatively, the first region 11 can be surrounded by the second region 12, which is not shown here for simplicity.

The first detecting module 721 is configured to detect the i-th first interruption command issued by the real-time clock in the i-th time unit.

The first retrieving module 722 is configured to retrieve, in response to the i-th first interruption command, the i-th first buffered image data corresponding to the i-th time unit using the second controller.

The first writing module 723 is configured to write the i-th first buffered image data into the first region, where i denotes an index.

The second changing unit 703 is configured to detect a time variation and activate the first controller to change the second region of the first image depending on an amount of the time variation after the time variation reaches a first predetermined threshold.

The solution according to this embodiment can be applied in the following scenario. Further to the example given in the first embodiment where the first application is an application for presenting advertisements, at the time 00:00:00, the display content of the first image of the first application is a Chinese character “ [symbol] ”, as shown in FIG. 1-3. At the time 00:00:20, the display content of the first image of the first application is changed into a Chinese character “ [symbol] ”. That is, the character “ [symbol] ” has been displayed for 20 seconds. At the time 00:00:40, the display content is changed into a Chinese character “ [symbol] ”. That is, the character “ [symbol] ” has been displayed for 20 seconds. At the time 00:01:00, the display content is changed into a Chinese character “ [symbol] ”. That is, the character “ [symbol] ” has been displayed for 20 seconds. Then, at the time 00:01:20, the display content is changed into a Chinese character “ [symbol] ”. That is, the character “ [symbol] ” has been displayed for 20 seconds. In this way, during the period from 00:00:00 to 00:01:19, the Chinese characters “ [symbol] ” have been displayed sequentially. Conventionally, the first image of the first application is changed entirely over time, i.e., the entire first image is changed each time the content of the first image is changed (i.e., at 00:00:00, 00:00:20, 00:00:40 and 00:01:20), without dividing the first image into two regions. In contrast, with the embodiment of the present disclosure, the first image is first divided into at least two regions depending on the frequencies or periods at which their respective contents are changed. Then, only the content in the first region 11 needs to be changed each time the content of the first image is changed (i.e., at 00:00:00, 00:00:20, 00:00:40 and 00:01:00), without changing the content in the second region 12.

In this embodiment, the first region of the first image is changed per time unit. In the above example, the content in the first region is changed every 20 seconds. In an implementation, a circuit for generating time units, e.g., a crystal oscillator circuit issuing a pulse signal every 20 seconds, can be incorporated into the electronic device and the content in the first region can be changed in response to obtaining such signal. It can be appreciated by those skilled in the art that the changing of the first region per time unit can be implemented in other ways, which will not be detailed here.

### 9^{th} Embodiment

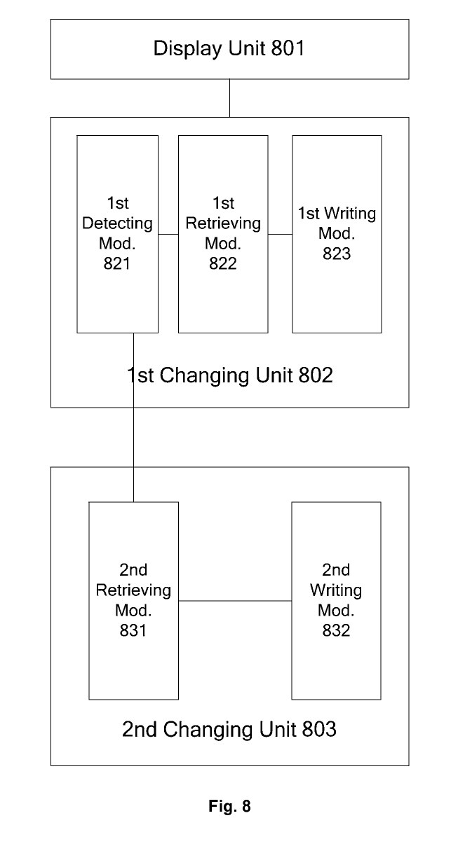

Based on the above method embodiments and sixth to eighth embodiments, according to this embodiment, an electronic device is provided. The electronic device includes a display unit, a real-time clock, a first controller and a second controller and has a first application installed thereon. The real-time clock is configured to issue a first interruption command per time unit. A first threshold includes M time units. FIG. 8 is a schematic diagram showing a structure of an electronic device according to a ninth embodiment of the present disclosure. As shown in FIG. 8, the electronic device includes a display unit 801, a first changing unit 802 and a second changing unit 803. The first changing unit 802 includes a first detecting module 821, a first retrieving module 822 and a first writing module 823. The second changing unit 803 includes a second retrieving module 831 and a second writing module 832.

The displaying unit 801 is configured to display a first image of the first application while the first application is running. The first image includes a first region and a second region.

Here, the first application can be any application having a display interface displayed on the display unit of the electronic device as the first image. The first application can be a game application, a clock application or an application for displaying advertisements, etc.

Here, the real-time clock (RTC) is a series of pulses generated by a clock circuit consisting of a crystal oscillator circuit in a main board of the electronic device. These pulses can be used for generating a system clock. It can be understood by those skilled in the art and the details thereof will be omitted here.

The first detecting module 821 is configured to detect the i-th first interruption command issued by the real-time clock in the i-th time unit, where i denotes an index.

Here, the first interruption command can be a pulse signal generated by the RTC.

The first retrieving module 822 is configured to retrieve, in response to the i-th first interruption command when it is determined that i is smaller than M, the i-th first buffered image data corresponding to the i-th time unit using the second controller.

The first writing module 823 is configured to write the i-th first buffered image data into the first region.

The second retrieving unit 831 is configured to retrieve, when it is determined that i is equal to M, the second buffered image data in response to the M-th first interruption command using the first controller.

The second writing module 832 is configured to control the second controller to write the second buffered image data into the second region using the first controller.

In this embodiment, the operations of changing the contents in the first and second regions are performed by two different controllers, respectively, i.e., the first region is changed by the second controller, while the second region is changed by the first controller. In an implementation, the first controller can be a GPU, which can be implemented by an MCU or a single chip machine, or an APU. When the first controller is a GPU, the second controller can be a display controller, e.g., a LCD controller.

The LCD controller can provide the electronic device with a continuous display data stream; otherwise the electronic device can display no image or distorted images. The LCD controller can be implemented by an MCU or a display memory.

Here, in the example where the first controller is a GPU and the second controller is a LCD controller, the step S303 of activating the first controller to change the second region of the first image includes activating the GPU to control the LCD controller to change the second region of the first image.

The technical effects of the embodiment of the present disclosure will be described with reference to the example where the first controller is a GPU and the second controller is a LCD controller. When the first application is running on the electronic device, the display interface is continuously updated over time. In order to update the display interface, the first application continuously wakes the GPU. Then, the GPU stores the content to be displayed in a memory of the LCD controller in a form of buffered image data, such that the LCD controller can read and display the buffered image data on the display unit. Conventionally, in doing so, the GPU is continuously woken to switch the display interface of the first application. In contrast, with the solution according to the embodiment of the present disclosure, the first image to be displayed for the first application is first divided into different regions, i.e., the first region and the second region, depending on frequencies or periods at which they are changed. The frequency at which the first region is changed is relatively high and the frequency at which the second region is changed is relatively low. Then, the LCD controller changes the first region in response to the first interruption command issued by the real-time clock. Finally, the GPU changes the second region. It can be seen that, when the first application switches the display interface, the GPU does not need to be woken each time the display interface is changed; rather, it only needs to be woken when the second region is to be changed. As shown in FIG. 3-2, the first graph in FIG. 3-2 shows the number of times the GPU is woken in the conventional solution, while the second graph in FIG. 3-2 shows the number of times the GPU is woken in the solution according to this embodiment. Hence, with the solution according to this embodiment, the number of times the display controller is woken can be effectively reduced, thereby reducing the power consumption of the electronic device and increasing the battery lifetime of the electronic device.

In the embodiment of the present disclosure, as shown in FIGS. 3-3 and 3-4, the memory of the second controller includes a first memory area 31 for storing the first buffered image data and a second memory area 32 for storing the second buffered image data. Here, as shown in FIG. 3-4, the first memory area 31 can be further divided into a number of memory area blocks, such as memory area blocks 311-314. The sizes of the respective memory region blocks can be the same or different. It can be appreciated by those skilled in the art that the second memory region can be divided into memory area blocks in any of various existing techniques and the description thereof will be omitted here.

In an embodiment of the present disclosure, the electronic device can include one RTC, i.e., the first RTC. As shown in FIG. 3-5, the first RTC is an RTC within the first controller and is connected to the second controller, such that the first RTC can issue a first interruption command to the second controller. FIG. 3-6 shows a related solution. The solution shown in FIG. 3-5 differs from the solution shown in FIG. 3-6 in that the first RTC needs to be connected to the second controller.

In an embodiment of the present disclosure, the electronic device can include two RTCs, i.e., a first RTC and an additional second RTC as shown in FIG. 3-7. The additional second RTC is connected to the second controller. The first and second RTCs may have the same clock frequency, or different clock frequencies. It can be understood by those skilled in the art and the details thereof will be omitted here.

### 10^{th} Embodiment

With the prevalence of consumer electronic products, users become more and more dependent on electronic devices such as mobile phones. These electronic devices have taken the place of watches as timing tools. However, the operation of an electronic device is dependent on its battery. Hence, the battery is very important to the electronic device. Given the capacity of the battery, the manufacture of the electronic device desires to reduce the power consumption, thereby increasing the battery lifetime.

According to this embodiment, an electronic device is provided. The electronic device includes a display unit, a real-time clock, a first controller and a second controller. The real-time clock is configured to issue a first interruption command per time unit. The electronic device has a clock application installed thereon. When executed, the clock application displays a clock involving variations of its hour hand, minute hand and second hand. Accordingly, the time unit is one second and the real-time clock issues a first interruption command per second.

The electronic device includes a display unit, a first changing unit and a second changing unit. The first changing unit includes a first detecting module, a first retrieving module and a first writing module. The second changing unit includes a second retrieving module and a second writing module.

The displaying unit is configured to display a first image of the clock application on the display unit of the electronic device while the clock application is running. The first image includes a first region and a second region.

Here, the first application can be any application having a display interface displayed on the display unit of the electronic device as the first image. The first application can be a game application, a clock application or an application for displaying advertisements, etc.

Here, the real-time clock (RTC) is a series of pulses generated by a clock circuit consisting of a crystal oscillator circuit in a main board of the electronic device. These pulses can be used for generating a system clock. It can be understood by those skilled in the art and the details thereof will be omitted here.

The first detecting module is configured to detect the i-th first interruption command issued by the real-time clock in the i-th time unit, where i denotes an index.

Here, the first interruption command can be a pulse signal generated by the RTC.

The first retrieving module is configured to retrieve, in response to the i-th first interruption command when it is determined that i is smaller than 59, the i-th first buffered image data corresponding to the i-th time unit using the second controller.

The first writing module is configured to write the i-th first buffered image data into the first region.

Here, the i-th first buffered image data corresponds to the first buffered image data for the i-th second.

The second retrieving unit is configured to, when it is determined that i is equal to 60, set i to zero and retrieve the second buffered image data in response to the 0-th first interruption command using the first controller.

The second writing module is configured to control the second controller to write the second buffered image data into the second region using the first controller and trigger the first detecting module.

The embodiment of the present disclosure can be applied in the following scenario. FIG. 5-2 is a schematic diagram showing a display interface when a clock application is running according to the fifth embodiment of the present disclosure. As shown in FIG. 5-2, conventionally the RTC is used for timing. The RTC interrupts the first controller by issuing the first interruption command per second. The first controller is woken to update the content to be displayed. Then, the second controller reads the buffered image data and updates the clock. In fact, during one minute, only the content in the gray region, i.e., the first region 51 representing the variation of the second hand, in FIG. 5-2 is changed, while the second region 52 other than the first region 51 is not changed from 0 to 59 seconds. With the solution according to the embodiment of the present disclosure, the first controller is woken once every minute. When compared with the conventional solution where the first controller has to be woken for 60 times every minute, the solution according to the embodiment of the present disclosure can effectively reduce the number of times the first controller is woken, thereby reducing the power consumption of the electronic device and increasing the battery lifetime of the electronic device.

In the embodiment of the present disclosure, as shown in FIGS. 3-3 and 3-4, the memory of the second controller includes a first memory area 31 for storing the first buffered image data and a second memory area 32 for storing the second buffered image data. The first memory area 31 can be further divided into 59 memory area blocks for storing the buffered image data for 1 to 59 seconds, respectively.

In an embodiment of the present disclosure, the electronic device can include one RTC, i.e., the first RTC. As shown in FIG. 3-5, the first RTC is an RTC within the first controller and is connected to the second controller, such that the first RTC can issue a first interruption command to the second controller. Alternatively, the electronic device can include two RTCs, i.e., a first RTC and an additional second RTC as shown in FIG. 3-7. The additional second RTC is connected to the second controller. It is to be noted here that the first and second RTCs should have the same clock frequency.

It can be appreciated from the embodiments of the present application that the disclosed device and method can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated unit can be implemented in hardware, possibly in combination with software functional units.

It can be appreciated by those skilled in the art that some or all of the steps in the method embodiment as described above can be implemented by hardware following instructions of a program. Such program can be stored in a computer readable storage medium and, when executed, performs the steps of the above method embodiment. The storage medium may be any of various medium capable of storing program codes, such as a mobile storage device, a Read Only Memory (ROM), a Random Access Memory (RAM), a magnetic disk or an optical disc.

Alternatively, the integrated units of the present disclosure as described above can be implemented as software functional modules and sold or used as standalone produces. In this case, they can be stored in a computer readable storage medium. In view of this, the technical solutions according to the embodiments of the present application, or in other words a part thereof which makes contribution over the prior art, can be substantially embodied in a form of software product. The computer software product can be stored in a storage medium containing instructions which cause a computer device (which can be a personal computer, a server, a network device or the like) to perform one or more methods according to the embodiments of the present application or particular parts thereof. The storage medium may be any of various mediums capable of storing program codes, such as a mobile storage device, a Read Only Memory (ROM), a Random Access Memory (RAM), a magnetic disk or an optical disc.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

What is claimed is:

1. An information processing method, applied in an electronic device including a display unit and a first controller and having a first application installed thereon, the method comprising:
displaying a first image of the first application on the display unit of the electronic device while the first application is running, the first image including a first region and a second region;
detecting a time variation and changing the first region of the first image in response to the time variation; and
activating the first controller to change the second region of the first image depending on an amount of the time variation after the time variation reaches a first predetermined threshold.

2. The method of claim 1, wherein the first region of the first image is changed per time unit, and
said detecting the time variation and changing the first region of the first image in response to the time variation comprises:
retrieving, during the i-th time unit, the i-th first buffered image data corresponding to the i-th time unit and writing the i-th first buffered image data into the first region, where i denotes an index.

3. The method of claim 1, wherein the electronic device further comprises a second controller and a real-time clock configured to issue a first interruption command per time unit, and
said detecting the time variation and changing the first region of the first image in response to the time variation comprises:
detecting the i-th first interruption command issued by the real-time clock in the i-th time unit;
retrieving, in response to the i-th first interruption command, the i-th first buffered image data corresponding to the i-th time unit using the second controller; and
writing the i-th first buffered image data into the first region, where i denotes an index.

4. The method of claim 1, wherein the electronic device further comprises a real-time clock configured to issue a first interruption command per time unit, and the first threshold comprises M time units, and
said activating the first controller to change the second region of the first image depending on an amount of the time variation when the time variation reaches the first predetermined threshold comprises:
detecting the i-th first interruption command issued by the real-time clock in the i-th time unit;
retrieving, when it is determined that i is equal to M, the second buffered image data in response to the M-th first interruption command using the first controller; and
controlling the second controller to write the second buffered image data into the second region.

5. The method of claim 3, wherein the second controller has a memory comprising a first memory area for storing the first buffered image data and a second memory area for storing the second buffered image data.

6. The method of claim 3, wherein the first application is a clock application displaying variations of a second hand, the time unit is one second, and the first threshold is 60 seconds,
the real-time clock is configured to issue a first interruption command per second, and
the first buffered image data comprises buffered data displayed for 0 to 59 seconds.

7. The method of claim 4, wherein the first application is a clock application displaying variations of a second hand, the time unit is one second, and the first threshold is 60 seconds,
the real-time clock is configured to issue a first interruption command per second, and
the first buffered image data comprises buffered data displayed for 0 to 59 seconds.

8. The method of claim 1, wherein the real-time clock of the electronic device comprises a first real-time clock, the first real-time clock being a real-time clock within the first controller and being connected to the first controller, or
the real-time clock of the electronic device comprises the first real-time clock and an additional second real-time clock that is connected to the first controller.

9. An electronic device including a display unit and a first controller and having a first application installed thereon, the electronic device comprising:
a displaying unit configured to display a first image of the first application on the display unit of the electronic device while the first application is running, the first image including a first region and a second region;
a first changing unit configured to detect a time variation and change the first region of the first image in response to the time variation; and
a second changing unit configured to activate the first controller to change the second region of the first image depending on an amount of the time variation after the time variation reaches a first predetermined threshold.

10. The electronic device of claim 9, wherein the first region of the first image is changed per time unit, and
the first changing unit is configured to retrieve, during the i-th time unit, the i-th first buffered image data corresponding to the i-th time unit and write the i-th first buffered image data into the first region, where i denotes an index.

11. The electronic device of claim 9, further comprising a second controller and a real-time clock configured to issue a first interruption command per time unit,
wherein the first changing unit comprises:
a first detecting module configured to detect the i-th first interruption command issued by the real-time clock in the i-th time unit;
a first retrieving module configured to retrieve, in response to the i-th first interruption command, the i-th first buffered image data corresponding to the i-th time unit using the second controller; and
a first writing module configured to write the i-th first buffered image data into the first region, where i denotes an index.

12. The electronic device of claim 9, further comprising a real-time clock configured to issue a first interruption command per time unit,
wherein the first threshold comprises M time units, and
the second changing unit comprises:
a first detecting module configured to detect the i-th first interruption command issued by the real-time clock in the i-th time unit;
a second retrieving unit configured to retrieve, when it is determined that i is equal to M, the second buffered image data in response to the M-th first interruption command using the first controller; and
a second writing module configured to control the second controller to write the second buffered image data into the second region using the first controller.

13. The electronic device of claim 11, wherein the second controller has a memory comprising a first memory area for storing the first buffered image data and a second memory area for storing the second buffered image data.

14. The electronic device of claim 11, wherein the first application is a clock application displaying variations of a second hand, the time unit is one second, and the first threshold is 60 seconds,
the real-time clock is configured to issue a first interruption command per second, and
the first buffered image data comprises buffered data displayed for 0 to 59 seconds.

15. The electronic device of claim 12, wherein the first application is a clock application displaying variations of a second hand, the time unit is one second, and the first threshold is 60 seconds,
the real-time clock is configured to issue a first interruption command per second, and
the first buffered image data comprises buffered data displayed for 0 to 59 seconds.

16. The electronic device of claim 9, wherein the real-time clock of the electronic device comprises a first real-time clock, the first real-time clock being a real-time clock within the first controller and being connected to the first controller, or
the real-time clock of the electronic device comprises the first real-time clock and an additional second real-time clock that is connected to the first controller.
